(19) United States
(12) Patent Application Publication
(10) Pub. No.: US 2016/0241096 A1
(43) Pub. Date: Aug. 18, 2016

(54) ASSEMBLY FOR AN ELECTRIC MACHINE, METHOD FOR PRODUCING AN ASSEMBLY AND ELECTRIC MACHINE HAVING AN ASSEMBLY

(71) Applicant: ROBERT BOSCH GMBH, Stuttgart (DE)

(72) Inventor: Tankred Mueller, Baden-Baden (DE)

(21) Appl. No.: 15/028,369

(22) PCT Filed: Aug. 29, 2014
(86) PCT No.: PCT/EP2014/068429

§ 371 Date: Apr. 8, 2016

(30) Foreign Application Priority Data
Oct. 11, 2013 (DE) 102013220562.7

(51) Int. Cl. H02K 1/28; H02K 1/27

(52) U.S. Cl. CPC H02K 1/28; H02K 1/274

(57) ABSTRACT

The invention concerns an assembly (10; 10a ; 10b) for an electric machine (1), comprising a rotor (12; 12a; 12b) which is rotatable in a rotational shaft (11) and magnet elements (15; 15a) which are disposed on the periphery of the rotor (12; 12a; 12b) and are connected thereto. According to the invention, the connection between the rotor (12; 12a; 12b) and the magnet elements (15; 15a) takes the form of a solder connection (25).

### BACKGROUND OF THE INVENTION

The invention relates to an assembly for an electric machine. The invention furthermore relates to a method for producing an assembly according to the invention as well as to and electric machine and to the application of said inventive assembly.

An assembly for an electric machine is already known from the technical field. This assembly is, for example, a constituent part of an electric motor, in which permanent magnet elements are disposed on the periphery of a rotatably mounted rotor, wherein the permanent magnet elements, referred to below simply as magnet elements, interact with fixed wire-wound coils which are disposed particularly in the region of a pole housing and through which current can be passed. Such magnet elements are attached to the periphery of the rotor in practice by means of adhesive bonding, bandaging or by means of a positive-locking connection between the magnet elements and the rotor. In addition, the process is known for integrating the magnet elements into the rotor structure. A mechanically fixed connection of the magnet elements to the rotor is desirable in each case in order to prevent said magnet elements from detaching from the periphery of the rotor as a result of centrifugal forces that occur during rotation of said rotor. A detachment of the magnet elements would inevitably lead to a malfunction or, respectively, to the destruction of the electric motor. A relatively simple mounting, which can procedurally be particularly well monitored, as well as a high degree of efficiency of an electric machine equipped with an assembly is desirable. A disadvantage with the magnet elements, which are either connected to the rotor in a positive-locking manner or by integration into the rotor structure, is that the electric machine has a relatively poor degree of efficiency as a result of magnetic interactions with the magnetically conductive rotor material. In the case of adhesively bonding the magnet elements to the rotor, it is considered disadvantageous that the adhesive tends to outgas and that a certain curing time is required in order for the magnet elements to be securely fixed to the rotor. During this curing time, a further handling of the rotor or, respectively, mounting of said rotor to the electric machine is at least temporarily not possible. In addition, the accuracy of mounting during an adhesive bonding process is, as the case may be, not optimal depending on the concrete circumstances. In the case of bandaging the magnet elements to the rotor structure, the material of the bandage enlarges the air gap between the wire windings and the magnet elements so that the achievable degree of efficiency is likewise reduced.

### SUMMARY OF THE INVENTION

Against the background of the prior art described above, the aim underlying the invention is to further develop an assembly for an electric machine according to the preamble of claim 1 in such a way that the disadvantages mentioned above can be avoided. According to the invention, an assembly for an electric machine meets this aim by virtue of the fact that the connection between the rotor and the magnet elements takes the form of a solder connection. A solder connection has as a type of metallurgically bonded connection in comparison to an adhesively bonded connection particularly the advantage that the magnet elements are connected to the rotor in a particularly fixed manner; thus enabling particularly high radial forces to be transferred. This has the advantage that an electric machine equipped with an assembly according to the invention enables particularly high rotational speeds to be realized. Furthermore, the connection can be loaded up to the melting temperature of the solder, wherein, depending on the selection of the solder, a relatively high temperature during operation in comparison to an adhesively bonded connection is possible. In the case of an adhesively bonded connection, such a high operating temperature is only possible if special adhesives are used, which are, as the case may be, relatively expensive and/or difficult to process. It is furthermore considered advantageous that an outgasing, such as when using adhesives, is avoided and that a particularly good thermal connection of the magnet elements to the rotor is achieved. The manufacturing and installation time of an inventive assembly is also reduced with respect to the prior art insofar as a curing time is not required as is the case when using an adhesive.

In a first modification to the assembly, provision is made for the magnet elements to be provided with a coating in order to improve the solderability thereof. In the case of NdFeB magnet elements, such a coating can, for example, be implemented with Ni when using a Sn-based solder.

In order to achieve the highest degree of efficiency possible, provision is furthermore made for the shape of the magnet elements to be at least substantially adapted to the shape of the cross section of the rotor at the connecting region with the magnet elements. That means that the magnet elements are especially designed in the shape of a circular arc section, wherein only the relatively thin solder layer has to be taken into account between the outer periphery of the rotor and the magnet elements.

In order to prevent mechanical stresses in the magnet material of the magnet elements, which, for example, arise as a result of the different thermal expansion coefficients between the material of the magnet elements and the rotor, provision is made in a further advantageous embodiment of the invention for the rotor to have at least one, preferably a plurality of slot-shaped recesses in the overlapping region with the respective magnet element, said recesses originating at the peripheral surface of the rotor. In the typical design of such motors or, respectively, magnet elements, the recesses furthermore extend parallel to the axis of rotation of the rotor.

A particularly good connection of the magnet elements to the rotor is achieved if the connection between the rotor and the magnet elements comprises a positive-locking connection in addition to the soldered connection.

In a concrete configuration, such a positive-locking connection provides at least one, preferably two, projection, which is disposed on opposite sides of the rotor or of the magnet elements and interacts with a mirror-inverted recess on the magnet element or the rotor. When using only one positive-locking connection, there is the advantage that only one solder connection is provided on a side between the rotor and the magnet element, while the positive-locking connection is preferably designed with some play particularly on a side opposite the solder connection. When the magnet element or, respectively, the rotor is heated up, such a design enables the corresponding element to expand in the region of the positive-locking connection; thus enabling mechanical stresses to be prevented or at least reduced.

In a method for producing an assembly according to the invention, in which the magnet elements are connected to the rotor by means of a metallurgically bonded connection, provision is made according to the invention for the magnet elements to be soldered to the rotor.

A fillet brazing, abrasion soldering or connection soldering method can be considered as possible suitable soldering methods.

In addition, it is conceivable in a first possible method for such magnet elements to be used as the magnet element, which are non-magnetized prior to being connected to the rotor. Such a method has the advantage that demagnetization losses in the case of magnetized magnet elements can be prevented particularly at relatively high temperatures as they typically occur during soldering (depending on the type of solder used). As a result, the use of a solder having a relatively high melting temperature (which therefore particularly allows for high thermal loads on the rotor) is also possible without additional measures needing to be taken and moreover without a poor degree of efficiency of the electrical machine having to be accepted due to weakly magnetized magnet elements.

Alternatively, it is however also possible for magnet elements to be used which are already magnetized prior to being connected to the rotor. Such a method can possibly be more easily integrated into the installation process from a manufacturing standpoint because a subsequent magnetization of the magnet elements can be omitted.

In order to prevent or reduce a demagnetization of the elements in the variant of the method which was last mentioned and in which magnetized magnet elements are used already prior to being connected to the rotor, provision can be made for the demagnetization temperature of the magnets to be increased during soldering to the rotor. Such an increase in the demagnetization temperature can be achieved through the use of a suitable device known from the prior art.

Provision can furthermore be made for the solder connection between the magnet elements and the rotor to be formed only across a section of the overlapping region in the circumferential direction in order, on the one hand, to simplify the manufacturing process and, on the other hand, to be able, if need be, to better compensate for mechanical stresses as a result of irregular stresses due to irregular heating of the magnet elements.

Finally, the invention also comprises an electric machine, in particular as a constituent part of a servo drive in a motor vehicle, which comprises an assembly according to the invention or, respectively, an assembly manufactured according to a method described. Such a servo drive in a motor vehicle is to be particularly understood as a power window drive, seat adjustment drive, sunroof drive or something similar; however is not to be limited to these options.

### BRIEF DESCRIPTION OF THE DRAWINGS

Further advantages, features and details of the invention ensue from the following description of preferred exemplary embodiments as well as with the aid of the drawings. In the drawings:

FIG. 1 shows a simplified cross section of an assembly according to the invention, in which a magnet element is connected to a rotor by means of a solder connection;

FIG. 2 shows an assembly which is modified with respect to FIG. 1 and in which a magnet element is additionally connected to the rotor by means of a positive-locking connection; and

FIG. 3 shows an assembly which is modified with respect to FIG. 1 by means of the use of slots on the rotor which extend in the longitudinal direction.

Identical elements or, respectively, elements having the same function are provided with the same reference numerals in the figures.

### DETAILED DESCRIPTION

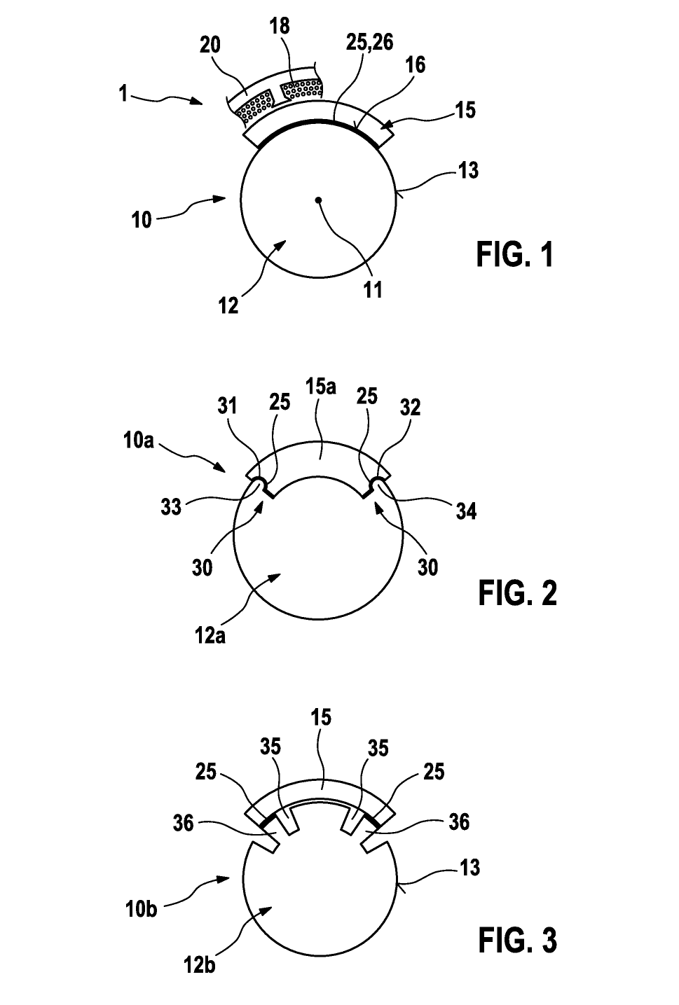

In FIG. 1, a first inventive assembly 10 for an electric machine 1 is depicted in a highly simplified manner. The machine 1 relates particularly to an electric motor as a constituent part of a servo drive in a motor vehicle, such as a seat adjustment drive, a power window drive, a sunroof drive or something similar. The invention should, however, not be limited to such applications of an assembly 10.

The assembly 10 comprises a rotor 12, which is rotatably mounted about an axis of rotation 11 and which in practice typically consists of a multiplicity of sheet metal elements which are stacked vertically on top of one another in the plane of the drawing of FIG. 1. Said sheet metal elements are rotatably mounted about an axis (not depicted) which simultaneously forms the axis of rotation. In the ideal case, the rotor 12 has a peripheral surface 13 which is formed in a circular cylindrical manner and on which a plurality of, at least two-in practice however, for example, four, magnet elements 15 are attached. For the sake of clarity, only one single magnet element 15 is depicted in the figures of the drawings. The magnet element 15 has the shape of a circular arc section such that the inner peripheral surface 16 of the magnet element 15 is substantially adapted to the peripheral surface 13 of the rotor 12. The magnet elements 15 of the assembly 10 interact with wire windings 18 through which current can alternately be passed and the wires of which extend substantially perpendicularly to the plane of the drawing in the figures. Furthermore, said wire windings 18 radially surround the magnet elements 15 so as to be spaced apart from the same at a small distance or, respectively, with a small air gap. To this end, the wire windings 18 are, for example, disposed on the inner periphery of a stator 20 of the machine 1 and additionally molded with the same.

According to the invention, provision is made for the connection between the magnet element 15 and the rotor 12 to take the form of a solder connection 25. In the exemplary embodiment depicted in FIG. 1, the solder 26 of the solder connection 25 that has a relatively small layer thickness is disposed between the peripheral surface 13 and the magnet element 15 in such a way that said solder runs across the entire circular arc section of the magnet elementl5. In this regard, a plurality of sections which are disposed perpendicularly to the plane of the drawing of FIG. 1 and are each circular arc-shaped can be provided with solder 26 so that the solder 26 is not disposed in the entire overlapping region between the rotor 12 and the corresponding magnet element 15. In a modification to the exemplary embodiment depicted in FIG. 1, provision can also be made for the solder 26 to run, for example, only over a subsection of the circular arc section between the magnet element 15 and the rotor 12 and, for example, perpendicularly to the plane of the drawing of FIG. 1 across the entire length of the magnet element 15.

In the assembly 10a depicted in FIG. 2, a positive-locking connection 30 between the rotor 12a and the magnet elements 15a is provided in addition to the solder connection 25. For this purpose, the magnet element 15a comprises in each case a recess 31, 32, which is formed approximately in a semicircle and interacts with a mirror-inverted raised section 33, 34 of the rotor 12a, in the longitudinal direction, i.e. perpendicularly to the plane of the drawing of FIG. 2, on the oppositely disposed end faces. The solder 26 of the solder connection 25 is situated in the region of the positive-locking connection 30, i.e. in particular in the region of the recesses 31, 32 as well as of the raised sections 33, 34. As a result of the solder 26 being situated in this region, a certain installation gap between the magnet element 15a and the rotor 12a is created, which facilitates the mounting of the magnet elements 15a on the rotor 12a.

The assembly 10b depicted in FIG. 3 differs from the assembly 10a according to FIG. 1 by virtue of the fact that at least one, in the depicted exemplary embodiment two, longitudinal slot 35 is formed in the overlapping region between the rotor 12b and the magnet element 15 in the peripheral surface 13 of the rotor 12b in the longitudinal direction, i.e. perpendicularly to the plane of the drawing of FIG. 3. Connection webs 36, on which the solder connection 25 is formed or, respectively, the solder 26 is disposed, are formed on the rotor 12b by means of the longitudinal slots 35. The rotor 12b furthermore has a central region 37 between the two connection webs 36 depicted in FIG. 3, between which central region 37 and the facing surface of the magnet element 15 a solder connection 25 is not formed.

It should be additionally noted that it is possible, in the case of all of the assemblies 10, 10a and 10b, to use magnet elements 15, 15a which were already magnetized prior to being soldered to the rotor 12, 12a, 12b as well as those which are first magnetized after the solder connection has been made. Provision can additionally be made for the magnet elements 15, 15a to be provided with a coating, in particular for the purpose of improving the solderability thereof. The invention can also fundamentally be applied to other types of machines, for example linear motors.

1. An assembly (10; 10a; 10b) for an electric machine (1), the assembly comprising a rotor (12; 12a; 12b) which is rotatable about an axis of rotation (11), and magnet elements (15; 15a) which are disposed on a periphery of the rotor (12; 12a; 12b) and are connected to said rotor (12; 12a; 12b), characterized in that a connection between the rotor (12; 12a; 12b) and the magnet elements (15; 15a) is a solder connection (25).

2. The assembly according to claim 1, characterized in that the magnet elements (15; 15a) have a coating which improves the solderability thereof.

3. The assembly according to claim 1, characterized in that a shape of the magnet elements (15; 15a) corresponds at least substantially to a shape of a cross section of the rotor (12; 12a; 12b) in a region of connection to the magnet elements (15; 15a).

4. The assembly according to claim 1, characterized in that the rotor (12b) comprises at least one recess; (35) in an overlapping region with a respective magnet element (15), said at least one recess originating at a peripheral surface (13) of the rotor (12b).

5. The assembly according to claim 1, characterized in that the connection between the rotor (12a) and the magnet elements (15a) additionally comprises a positive-locking connection (30).

6. The assembly according to claim 5 characterized in that the positive-locking connection (30) comprises at least one, projection (33, 34) which is disposed on one of the rotor (12a) and the magnet element (15a) and which interacts with a mirror-inverted recess (31, 32) in the other of the rotor and the magnet element (15a).

7. A method for producing an assembly (10; 10a; 10b) according to claim 1, in which the magnet elements (15; 15a) are connected to the rotor (12; 12a; 12b) by a metallurgically bonded connection, characterized in that the magnet elements (15; 15a) are soldered to the rotor (12; 12a; 12b).

8. The method according to claim 7, characterized in that the magnet elements are soldered to the rotor by a fillet brazing or abrasion or connection soldering method.

9. The method according to claim 7, characterized in that non-magnetized magnet elements (15; 15a) are used as the magnet elements (15; 15a), which are first magnetized after being connected to the rotor (12; 12a; 12b).

10. The method according to claim 7, characterized in that the magnet elements (15; 15a) are magnetized prior to being connected to the rotor (12; 12a; 12b).

11. The method according to claim 10, characterized in that a demagnetization temperature of the magnet elements (15; 15a) is raised when said magnet elements are being soldered to the rotor (12; 12a; 12b).

12. The method according to claim 7, characterized in that the solder connection (25) between the magnet elements (15; 15a) and the rotor (12a; 12b) is only formed across a section of an overlapping region in a circumferential direction.

13. An electric machine (1) comprising an assembly (10; 10a; 10b) according to claim 1.

14. The assembly according to claim 1, characterized in that a shape of the magnet elements (15; 15a) corresponds at least substantially to a shape of a cross section of the rotor (12; 12a; 12b) in a region of connection to the magnet elements (15; 15a) and is designed as a circular arc section.

15. The assembly according to claim 1, characterized in that the rotor (12b) comprises a plurality of slot-shaped recesses (35) in an overlapping region with a respective magnet element (15), said recesses originating at a peripheral surface (13) of the rotor (12b).

16. The assembly according to claim 1, characterized in that the connection between the rotor (12a) and the magnet elements (15a) additionally comprises a positive-locking connection (30).

17. The assembly according to claim 16 characterized in that the positive-locking connection (30) comprises projections (33, 34) which are disposed on opposite sides of one of the rotor (12a) and the magnet element (15a) and which interact with respective mirror-inverted recesses (31, 32) in the other of the rotor and the magnet element (15a).
